(19) United States
(12) Patent Application Publication
(10) Pub. No.: US 2018/0186424 A1
(43) Pub. Date: Jul. 5, 2018

(54) FOLDING LOCK MECHANISM

(71) Applicant: EcoReco Global Corporation, Victoria (SC)

(72) Inventors: Jay SUNG, Victoria (SC); Haoyu FENG, Victoria (SC); Kevin LEE, Victoria (SC)

(21) Appl. No.: 15/398,902

(22) Filed: Jan. 5, 2017

(51) Int. Cl. B62K 15/00; F16B 1/04

(52) U.S. Cl. CPC B62K 15/006; B62K 3/002; F16B 1/04

(57) ABSTRACT

A folding lock mechanism includes a fixing seat, a turning element, a first positioning component, a second positioning component, and a connection component. The fixing seat is connected to a front end of the footrest and provided with a first positioning part at one end thereof. The turning element has a second positioning part and a front end of which is coupled to the operation lever, and the turning element is pivotally connected with the fixing seat. The first positioning component is connected with the turning element in a way capable of relatively reciprocating rotation, and is capable of being engaged with the first positioning part. The second positioning component is connected with the fixing seat in a way capable of relative reciprocating rotation, wherein the second positioning component is provided with an engaging part at one end thereof for being engaged with the second positioning part. The connection component is connected between the first positioning component and the second positioning component. When the second positioning component is turned to disengage the engaging part from the second positioning part, the second positioning component drives the first positioning component via the connection component to disengage from the first positioning part.

### BACKGROUND

### 1. Technical Field

The present disclosure generally relates to a folding lock mechanism; particularly, the present disclosure relates to a folding lock mechanism for disengaging at least two separate locking components simultaneously with one action.

### 2. Description of the Related Art

As population densities and the trend toward energy saving solutions increases, personal mobility vehicles are increasingly becoming a relevant and practical means of transport for saving both time and energy while allowing users to easily bypass congestion. Typical of these personal mobility vehicles, in order for them to be truly convenient, they are usually designed to be equipped with folding structures for storing purposes. When unfolded and in the riding mode, the folding structure requires multiple locking mechanisms to ensure that the personal mobility vehicle does not become unstable once the personal mobility vehicle is at speed. However, when the personal mobility vehicle is to be stored in the folded state, the procedure for unlocking the multiple locking mechanisms is complicated and becomes a tedious chore for the user.

### SUMMARY

It is an objective of the present disclosure to provide a folding lock mechanism that can disengage multiple locking components with a single action.

It is another objective of the present disclosure to provide a folding lock mechanism that increases stability while locking mechanisms thereof are engaged while also increasing convenience of unlocking procedure of the locking mechanisms when disengaging.

According to one aspect of the invention, a folding locking mechanism for a mobility vehicle is provided. The mobility vehicle has an operation lever and a footrest, wherein at least one front wheel is provided at a lower end of the operation lever and at least one rear wheel is provided at a rear end of the footrest. The folding lock mechanism includes a fixing seat, a turning element, a first positioning component, a second positioning component, and a connection component. The fixing seat is connected to a front end of the footrest and provided with a first positioning part at one end thereof. The turning element has a second positioning part and a front end of which is coupled to the operation lever, and the turning element is pivotally connected with the fixing seat. The first positioning component is connected with the turning element in a way capable of relatively reciprocating rotation, and is capable of being engaged with the first positioning part. The second positioning component is connected with the fixing seat in a way capable of relative reciprocating rotation, wherein the second positioning component is provided with an engaging part at one end thereof for being engaged with the second positioning part. The connection component is connected between the first positioning component and the second positioning component. When the second positioning component is turned to disengage the engaging part from the second positioning part, the second positioning component drives the first positioning component via the connection component to disengage from the first positioning part.

According to another aspect of the invention, the folding lock mechanism has a fixing seat, a turning element, a first positioning component, and a second positioning component. The fixing seat is connected to front end of the footrest and provided with a first positioning part at one end thereof. The turning element has a positioning part and a front end of which is coupled to the operation lever, and the turning element is pivotally connected with the fixing seat. The first positioning component connected with the turning element in a way capable of relatively reciprocating rotation, the first positioning component is capable of being engaged with the first positioning part. The second positioning component connected with the fixing seat in a way capable of relative reciprocating rotation, wherein the second positioning component has an engaging part at one end thereof for being engaged with the second positioning part. When the second positioning component is turned to disengage the engaging part from the second positioning part, an end of the second positioning component disengages the first positioning component from the first positioning part.

### BRIEF DESCRIPTION OF THE DRAWINGS

FIG. 1 is a view of an embodiment of the mobility vehicle with the folding lock mechanism of the present disclosure;

FIG. 2 is an embodiment of the folding lock mechanism of the present disclosure;

FIG. 3 is an exploded view of the embodiment of the folding lock mechanism of FIG. 2;

FIG. 4 is a cross-sectional side view of the embodiment of the folding lock mechanism of FIG. 3;

FIG. 5 is an embodiment of the first positioning component driving the second positioning component to disengage from the first positioning part;

FIG. 6 is an embodiment of the turning element being turned relative to the fixing seat;

FIG. 7 is an embodiment of the mobility vehicle in the folded state with the folding lock mechanism of FIG. 6;

FIG. 8 is another embodiment of the folding lock mechanism of FIG. 4;

FIG. 9 is an embodiment of the folding lock mechanism of FIG. 8 when the second positioning component drives the first positioning component to disengage from the first positioning part;

FIG. 10 is an embodiment of the turning element being turned relative to the fixing seat of FIG. 9;

FIG. 11 is another embodiment of FIGS. 2 and 3;

FIGS. 12-14 are embodiments of the folding lock mechanism transitioning from the unfolded state to the folded state;

FIGS. 15-18 are embodiments of the folding lock mechanism transitioning from the folded state to the unfolded state; and

FIG. 19 is another embodiment of the fixing seat.

### DETAILED DESCRIPTION OF THE PREFERRED EMBODIMENT

Embodiments of the present invention provide a folding lock mechanism for mobility vehicles. In the following detailed description, references are made to the accompanying drawings that form a part hereof, and in which are shown by way of illustration specific embodiments or examples. These embodiments are only illustrative of the scope of the present invention, and should not be construed as a restriction on the present invention. Referring now the drawings, in which like numerals represent like elements through the several figures, aspects of the present invention and the exemplary operating environment will be described.

The present disclosure provides a folding lock mechanism for mobility vehicles. In preferred embodiments, the mobility vehicle can include gas or electric powered personal vehicles, such as 2, 3, or 4 wheeled scooters. However, the folding lock mechanism of the present disclosure is not limited or restricted to these applications.

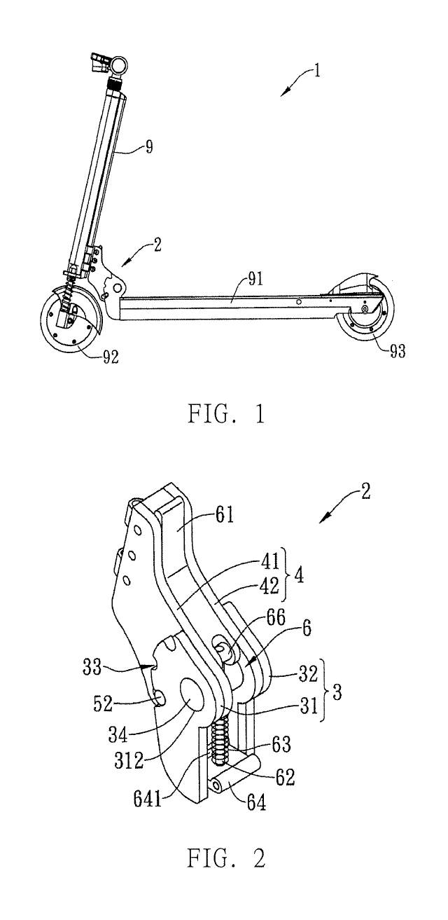

Referring to FIG. 1, an embodiment of the folding lock mechanism 2 of the present disclosure is shown. In the present embodiment, the folding lock mechanism 2 is installed on an electric scooter 1, wherein the electric scooter 1 includes an operation lever 9, a footrest 91, and the folding lock mechanism 2. A front wheel 92 is provided at a lower end of the operation lever 9 and a rear wheel 93 is provided at a rear end of the footrest 91. The folding lock mechanism 2 is connected between the operation lever 9 and the footrest 91, wherein the folding lock mechanism 2 can be folded or rotated such that the operation lever 9 can be rotated or folded onto the footrest 91.

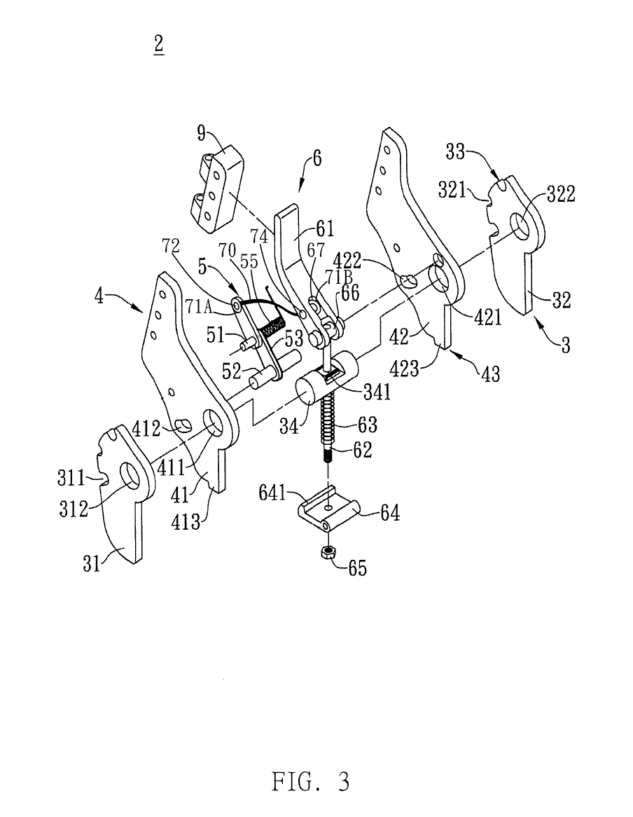

FIG. 2 is an embodiment of the folding lock mechanism 2 and FIG. 3 is an exploded view of an embodiment of FIG. 2. Referring to FIGS. 2 and 3, the folding lock mechanism 2 has a fixing seat 3, a turning element 4, a first positioning component 5, and a second positioning component 6.

The fixing seat 3 includes a left fixing plate 31 and a right fixing plate 32. As shown in FIGS. 2 and 3, the left fixing plate 31 and the right fixing plate 32 of the fixing seat 3 are gapped apart from each other and sandwich the turning element 4, the first positioning component 5, and the second positioning component 6. In the present embodiment, the left fixing plate 31 and the right fixing plate 32 are coplanar with respect to each other. However, in other different embodiments, the left fixing plate 31 and the right fixing plate 32 may not necessarily be coplanar with each other, or may not even be plate-shaped.

As shown in FIGS. 2 and 3, the left fixing plate 31 is provided with a plurality of left recesses 311 at the front periphery thereof while the right fixing plate 32 is provided with a plurality of right recesses 321 at front periphery thereof. In the present embodiment, the front periphery of the left fixing plate 31 and the right fixing plate 32 refers to the area or portion of the left fixing plate 31 and the right fixing plate 32 respectively that is closer to the operation lever 9 and the front wheel 92 (please refer to FIG. 1). Each left recess 311 has a corresponding right recess 321, wherein a pair of corresponding left recess 311 and right recess 321 forms a first positioning part 33. For instance, in the present embodiment, the left fixing plate 31 is provided with three left recesses 311, while the right fixing plate 32 also correspondingly has three right recesses 321. In this manner, the top left and right recesses form a corresponding pair, the middle left and right recesses form another corresponding pair, and the bottom left and right recesses form the final corresponding pair. It should be noted that although only three pairs of corresponding left and right recesses are shown in the present embodiment, any other different number of corresponding pairs of left and right recesses may be implemented in other different embodiments.

Referring still to FIGS. 2 and 3, the rear periphery (opposite of the front periphery) of the left fixing plate 31 and the right fixing plate 32 are respectively fixed to the front end of the footrest 91 of FIG. 1. In the present embodiment, the left fixing plate 31 and the right fixing plate 32 are respectively provided with a pivotal hole 312 and 322. The two pivotal holes are pivotally connected with each other via a pivot 34, wherein the pivot 34 is provided with a guiding hole 341. In other words, the pivotal hole 312 and the pivotal hole 322 line up with each other respectively, and the ends of the pivot 34 are inserted into the pivotal hole 312 and the pivotal hole 233 respectively.

The turning element 4 is positioned between the left fixing plate 31 and the right fixing plate 32. In the present embodiment, the turning element 4 includes a left turning plate 41 and right turning plate 42, as shown in FIGS. 2 and 3. The left turning plate 41 is provided with an axial hole 411, while the right turning plate 42 is provided with a corresponding axial hole 421. As shown in FIGS. 2 and 3, the axial hole 411 and the axial hole 421 are coaxial with the pivotal hole 312 and the pivotal hole 322 of the fixing seat 3. The pivot 4 passes through the pivotal holes 312 and 322, as well as the axial holes 411 and 421. In this manner, the turning element 4 is pivotally connected with the fixing seat 3, wherein the turning element 4 can be rotated relative to the fixing seat 3.

In the present embodiment, the front ends of the left turning plate 41 and right turning plate 42 are respectively connected to the operation lever 9 (as shown in FIG. 1). The left turning plate 41 is provided with a curved-shape left guiding groove 412, while the right turning plate 42 is provided with a corresponding right guiding groove 422. A left downward protruding part 413 is formed at the lower end of the left turning plate 41, while a corresponding right downward protruding part 423 is formed at the lower end of the right turning plate 42. The left downward protruding part 413 and the right downward protruding part 423 together form a second positioning part 43.

As shown in FIGS. 2 and 3, the first positioning component 5 is positioned between the left turning plate 41 and the right turning plate 42. In the present embodiment, the first positioning component 5 includes a straight rod 51, a positioning rod 52, a first connection plate 53, a second connection plate 54, and an elastic piece 55. The straight rod 51 and the positioning rod 52 are arranged to be parallel to each other. Two ends of the first connection plate 53 are respectively connected with the straight rod 51 and the positioning rod 52 such that the arrangement of the straight rod 51, the positioning rod 52, and the first connection plate 53 are generally in a H-shape.

In the present embodiment, the two ends of the straight rod 51 are pivotally connected with the left turning plate 41 and right turning plate 42, wherein one end of the straight rod 51 is connected with the second connection plate 54. The first connection plate 53 and the second connection plate 54 together preferably form a substantially straight shape. In other words, the first connection plate 53 and the second connection plate 54 connected to each other, wherein the straight rod 51 passes through the first, connection plate 53 and the second connection plate 54. However, in other different embodiments, the first connection plate 53 and the second connection plate 54 can be formed as one single piece.

As shown in FIG. 3, in the present embodiment, the elastic piece 55 is a torsion spring that is fitted onto the other end of the straight rod 51. As mentioned, the straight rod 51 is pivotally connected to the left turning plate 41 and the right turning plate 42. In this manner, straight rod 51 can be rotated along its axis. With the first connection plate 53 and the second connection plate 54 connected to the straight rod 51, the first connection plate 53 and the second connection plate 54 can rotate about the axis of the straight rod 51 when the straight rod 51 rotates. Since the elastic piece 55 fitted onto the straight rod 51, after the straight rod 51 is rotated about its axis, the elastic piece 55 can return the the straight rod 51 to its original position.

In the present embodiment, the two ends of the positioning rod 52 respectively pass through the left guiding groove 412 and the right guiding groove 422. When the folding lock mechanism is in a “locked” position, the two ends of the positioning rod 52 are at least engaged into one of the pairs of corresponding left recesses 311 and right recesses 321 of the first positioning part 33. Therefore, since the first connection plate 53 is connected to the positioning rod 52 and the straight rod 51, if a force is applied to turn the straight rod 51 to disengage the positioning rod 52 from the positioning part 33, the elastic piece 55 can return the straight rod 51 back to its original position after the force disappears. In other words, the elastic piece 55 can return the positioning rod 52 to its original position through the straight rod 51 such that the positioning rod 52 reengages with the positioning part 33.

As illustrated in FIG. 3, the second positioning component 6 is positioned between the left turning plate 41 and the right turning plate 42 and is located at the rear side of the first positioning component 5 (comparatively to the front wheel 92 and lever 9 of FIG. 1). In the present embodiment, the second positioning component 6 includes an eccentric handle 61, a pull rod 62, a spring 63, an engaging piece 64, and an adjustable nut 65. The eccentric handle 61 has a lower end pivotally connected with a rod 66. The left and right ends of the rod 66 are respectively pivotally connected to the left turning plate 41 and right turning plate 42. The pull rod 62 is an elongate rod. The top end of the pull rod 62 is connected to the rod 66. After the pull rod 62 is inserted through the guiding hole 341 of the pivot 34 and the engaging piece 64, the lower end of the pull rod 62 is screwed with the adjustable nut 65. The spring 63 is fitted on the pull rod 62. One end of the engaging piece 64 is pivotally connected to the front end of the footrest 91 while another end of the engaging piece 64 is provided with an engaging part 641 protruding upward. Thereby, the second positioning component 6 is connected to the fixing seat 3 in a way capable of relative reciprocating rotation.

Additionally, as illustrated in FIG. 3, a connection component 70 is connected between the first positioning component 5 and the second positioning component 6. In the present embodiment, the connection component 70 is formed in the shape of a string having two washers 71A and 71B at its ends, wherein the connection component 70 is preferably formed from metallic material to ensure longevity of the component throughout the product life span of the folding lock mechanism 2. The washer 71A is positioned at the end of the second connection plate 54 away from the straight rod 51 (ie. positioned at the end of the second connection plate 54 that the straight rod 51 is not located at). The washer 71A can then be securely screwed to the second connection plate 54. At the other end of the connection component 70, the washer 71B can be inserted through a hole 67 of the eccentric handle 61, wherein the hole 67 runs perpendicular to the direction of the axis of the rod 66. The eccentric handle 61 also has a through-hole 74 that runs parallel to the axis of the rod 66 and through the hole 67. In this manner, when the washer 71B is inserted into the hole 67, a rod or screw may be inserted through the though-hole 74 to securely fix the washer 71B within the hole 67. Through this design of the connection component 70, users may easily install and/or replace the connection component 70 via the two simple screws/pins that are securing the washers 71A and 71B. This decreases service cost of the product and simplifies maintenance procedures for the users.

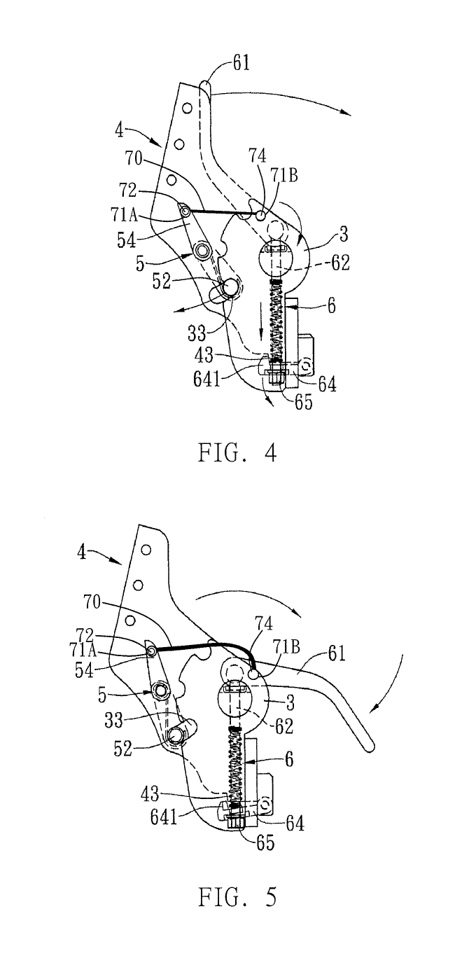

FIGS. 4-7 refer to embodiments of FIGS. 2 and 3 where a user operates the folding lock mechanism 2, wherein FIGS. 4-7 are viewed from the left side of the folding lock mechanism 2.

As illustrated in FIG. 4, when a user presses down the eccentric handle 61 in a clockwise direction, the pull rod 62 is moved downward as an effect of the eccentric handle 61 being turned clockwise. The engaging piece 64 is then swung downward by the pull rod 62 moving downward such that the second positioning part 43 at the lower end of the turning element 4 becomes detached from the engaging part 641 of the engaging piece 64. In addition, since the eccentric handle 61 is connected to the second connection plate 54 through the connection component 70, when the eccentric handle 61 is turned clockwise, the second connection plate 54 will be pulled along by the connection component 70 such that the positioning rod 52 can become disengaged or detached from the first positioning part 33, as shown in FIG. 5.

In other words, through the single action of pulling down the eccentric handle 61 of the second positioning component 6, the first positioning component 5 can be driven through the connection component 70 to disengage from the first positioning part 33 of the fixing seat 3 at the same time that the eccentric handle 61 also causes the engaging part 641 of the engaging piece 64 to disengage from the second positioning part 43 of the turning element 4. By keeping the eccentric handle 61 in the downward position in FIG. 5, the connection component 70 will continue to pull on the second connection plate 54 such that the positioning rod 52 will stay disengaged from the first positioning part 33.

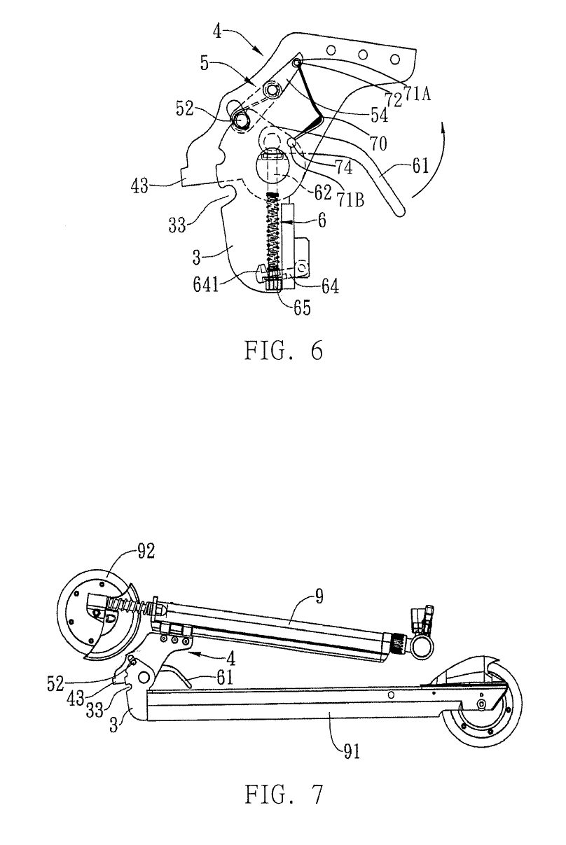

When the positioning rod 52 is disengaged from the first positioning part 33 and the engaging piece 64 is disengaged from the second positioning part 43, the turning element 4 may be rotated clockwise relative to the fixing seat 3 (as shown in FIG. 6). In this manner, the lever 9 and front wheel 92 assembly can be folded towards the footrest 91 as illustrated in FIG. 7.

Referring to FIGS. 5 and 6, with the eccentric handle 61 pressed in the downward position, when the turning element 4 is rotated clockwise with respect to the fixing seat 3, the connection component 70 may become loose or slack (ie. not taut) to the point that the rotation of the first positioning component 5 cannot be driven by the eccentric handle 61 (ex. rotating the turning element 4 such that the positioning rod passes the positioning part 33 of the middle pair of recesses). In this circumstance, the elastic piece 55 will try to rotate the first positioning component 5 back to its original position. However, since the entire turning element 4 is being rotated clockwise with respect to the fixing seat 3, the positioning rod 52 will slide or roll against the edge of the front periphery of the fixing seat (ie. front periphery of the left fixing plate 31 and the right fixing plate 32 of FIGS. 2-3) until the turning element 4 has been rotated with respect to the fixing seat 3 to the point where the positioning rod 52 clicks into or engages the positioning part 33 of the top pair of corresponding left and right recesses of the fixing seat 3. In this manner, users have a simple feedback (“click” sound) and can intuitively know that the folding lock mechanism 2 is in the locked position of the folded state. In the present embodiment, when the folding lock mechanism 2 is in the folded state, users can then turn the eccentric handle 61 back counter-clockwise towards the end of the turning element 4 connected with the operation lever 9.

When the folding lock mechanism 2 is being unfolded from the locked position in the folded state, users may apply pressure on the turning element 4 to rotate counter-clockwise relative to the fixing seat 3 in order to sufficiently unseat the positioning rod 52 from the positioning part 33 of the top pair of corresponding left and right recesses of the fixing seat 3. In other words, as the turning element 4 is unfolded, the positioning rod 52 will roll or slide along the contour of the positioning part 33 of the top pair of corresponding left and right recesses until the positioning rod 52 is completely disengaged from that particular positioning part 33. From there, as the turning element 4 is continued to be unfolded from the fixing seat 3, the connection component 70 will gradually become more taut.

With repeated use for a long period of time, the connection between the second positioning part 43 at the lower end of the turning element 4 and the engaging part 641 of the engaging piece 64 may become loose. In one embodiment, by means of controlling the adjustable nut 65, the engaging force of the engaging part 641 with the second positioning part 43 can be adjusted by the users such that the engaging part 641 can more effectively engage with the second positioning part 43.

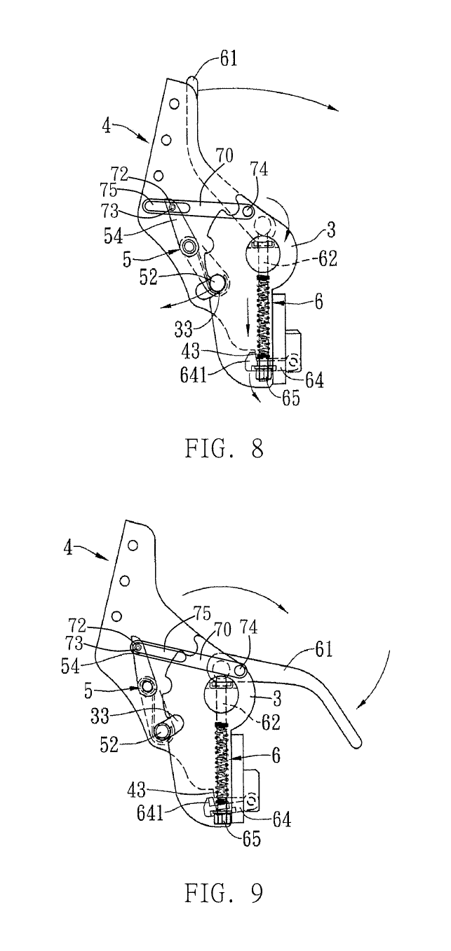

FIGS. 8-9 are another embodiment of FIGS. 4-6, wherein the connection component 70 is in the form of a long strip shape. Referring to FIG. 8, instead of the washer-string-washer form of FIGS. 4-6, the connection component 70 may also be in the form of a long strip plate, wherein the connection component 70 has a closed elongated hole 75 on one end and a hole 74 on the other end. In the present embodiment, the length of the elongated hole 75 may be adjusted according to design requirements. As shown in FIG. 8, the end of the connection component 70 having the elongated hole 75 is positioned at or aligned to overlap with the end of the second connection plate 54. A roller or screw head 72 larger than the shortest distance gap of the elongated hole 75 can then be screwed onto the second connection plate 54 such that the connection component 70 is sandwiched between the roller/screw head 72 and the second connection plate 54 (wherein the roller/screw head will be positioned to roll/move within the boundaries of the elongated hole 75).

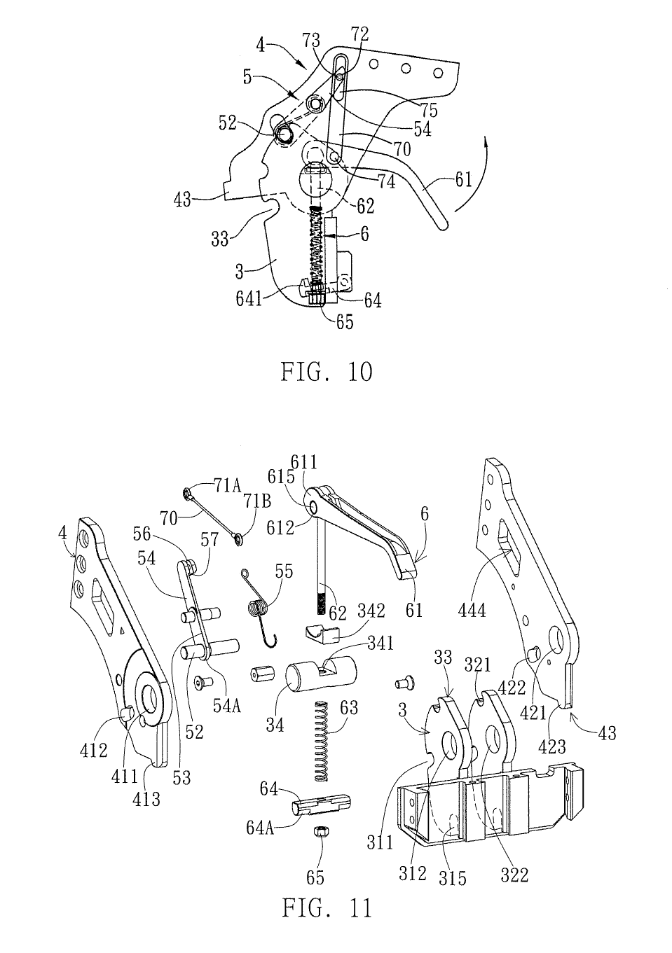

As shown in FIG. 9, when the eccentric handle 61 is pulled downwards clockwise, the eccentric handle 61 will pull on the connection component 70 until the roller or screw head 72 moves from a position somewhere closer to the right side in the elongated hole 75 to being completely on the left side of the elongated hole 75. From there, as the eccentric handle 61 is then continued to be pressed downward clockwise, the pull on the connection component 70 by the eccentric handle 61 will cause or drive the first positioning component 5 to rotate (since the roller or screw head 72 will be at the left-most position in the elongated hole 75) such that the positioning rod 52 will disengage from the first positioning part 33. In similar fashion to the previous embodiments, the pressing down of the eccentric handle 61 will also cause the engaging part 641 of the engaging piece 64 to disengage from the second positioning part 43 of the turning element 4. Users can then rotate the turning element 4 clockwise with respect to the fixing seat 3 to fold the lever 9 towards the footrest 91. As shown in FIG. 10, once the turning element 4 is rotated with respect to the fixing seat 3 to fold the lever 9 towards the footrest 91, the eccentric handle 61 can be retracted back towards the turning element 4 for better handling when the user is carrying the device in the folded mode.

FIG. 11 illustrates another embodiment. As shown in FIG. 11, in comparison the embodiment shown in FIGS. 2 and 3 where the fixing seat 3 sandwiches the turning element 4, the embodiment of FIG. 11 instead has the turning element 4 sandwiching the fixing seat 3. In the present embodiment, by having the turning element 4 sandwich the fixing seat 3 instead of the fixing seat 3 sandwich the turning element 4, more space can be created in between the turning element 4. In this manner, users have more space to operate when replacing components or servicing the device. For instance, when replacing the connection component 70 and/or spring 63 as an example, users will find that they will have more space to maneuver in between the turning element 4. As illustrated in FIG. 11, users will also find that there is more space to maneuver in between the turning element 4 when trying to tighten the adjustable nut 65 so that the engaging piece 64 can be more tightly engaged with the second positioning part 43.

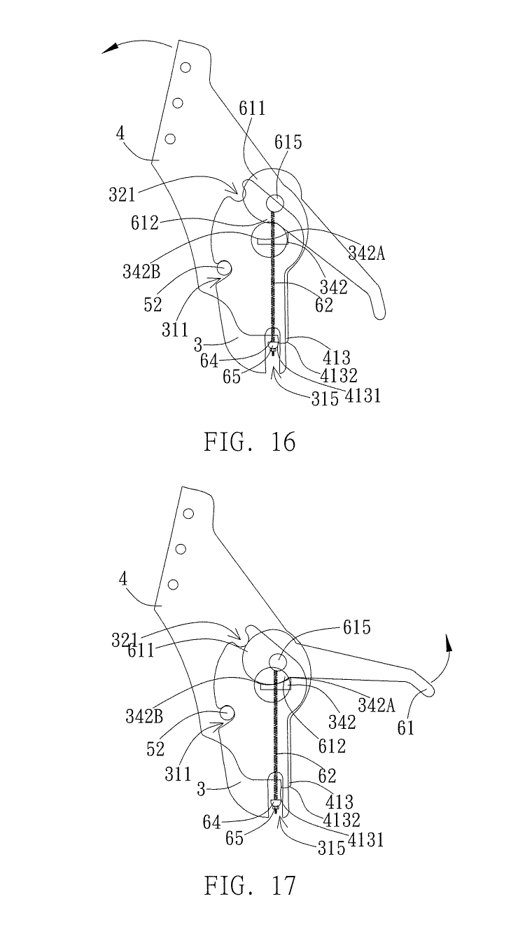

In addition, in the present embodiment, an access hole 444 may be formed on the turning element 4. This access hole 444 may be formed in any of the previously mentioned embodiments or the following embodiments. As illustrated in FIG. 11, in addition to the access hole 444 playing a role in the aesthetics of the product, further weight savings may be realized via the access hole 444 and help increase portability and battery range of the mobility vehicle. However, the access hole 444 also plays another crucial role in allowing users access to the end of the second connection plate 54 where the connection component 70 is connected. As shown in FIG. 11, the end of the second connection plate 54 where the connection component 70 connects to may have a connection part 57, wherein the connection part 57 has a slit 56 for the washer 71A of the connection component 70 to fit in and be screwed or fixed to the second connection plate 54. In the present embodiment, when the eccentric handle 61 is positioned substantially in the positions shown of the eccentric handle 61 in FIGS. 5 and 9 (or FIGS. 16 and 17), regardless of the form of the second connection plate 54 and/or the connection component 70, the connection or joint between the second connection plate 54 and the connection component 70 will be exposed or accessible through the access hole 444 when the eccentric handle 61 is positioned at these positions. In other words, when the folding lock mechanism of the present invention is in a locked position either in the folded or unfolded state, this joint is not exposed by the access hole 444 and is protected by the turning element 4. However, when the eccentric handle 61 is positioned at these positions when the folding lock mechanism is in the unfolded state, this joint can be accessed and serviced through the access hole 444. In this manner, maintenance or replacement on the connection component 70 can be easily performed.

It should be noted that since the function and action of the connection component 70 with its washers 71A and 71B in relation to the eccentric handle 61, the positioning rod 52, and the fixing seat 3 has already been described in great deal, the following embodiments will not go in further detail to describe these components. In addition, the following embodiments can be utilized in conjunction with or without the connection component 70.

In the present embodiment, the engaging piece 64 has an engaging part 64A for engaging with the second positioning part 43. As shown in FIG. 11, the engaging part 64A can consist of two flat surfaces that respectively extend to the two side ends of the engaging piece 64. Preferably, the two flat surfaces are coplanar with each other. However, in other different embodiments, the two flat surfaces may be non-coplanar with each other. In other words, in order for the non-coplanar surfaces to engage with the second positioning part 43, the surfaces of the left downward protruding part 413 and the right downward protruding part 423 of the second positioning part 43 that respectively engage with the two flat surfaces of the engaging part 64A may also be correspondingly non-coplanar.

In the present embodiment, the joint or pivot 615 between the pull rod 62 and the eccentric handle 61 is positioned off-center from the end portion (circular shape) 612 at the end of the eccentric handle 61 that attaches to the pull rod 62. In this manner, the distance between the center of the pivot 615 with the edge of the end portion 611 (of the eccentric handle 61) is greater than the distance between the center of the pivot 615 to the edge of the end portion 612.

Referring to FIGS. 11 and 12, in the present embodiment, a shim part 342 may be inserted into the pivot 34 at the guiding hole 341 to more stably hold the eccentric handle 61 while the eccentric handle 61 is being rotated. As shown in FIG. 11, the top surface of the shim part 342 facing the eccentric handle 61 is curved to correspond to the curvature of the circular shape (circular part) of the end (end portion 611 and 612) of the eccentric handle 61.

As illustrated in FIGS. 11 and 12, the shim part 342 has a first side 342A and a second side 342B that are parallel to the axial direction of the pivot 34 and perpendicular to the bottom surface of the shim part 342. In the present embodiment, the first side 342A faces towards the direction of the footrest 91 and rear wheel 93 (refer to FIG. 1), while the second side 342B faces in the opposite direction towards the front. In addition, the first side 342A has a height greater than the second side 342 such that the top surface that is curved and corresponding to the end portions 611 and 612 of the eccentric handle 61 curves up higher along the direction from the second side 342B to the first side 342A.

In the present embodiment, when the folding lock mechanism is in the unfolded state, the distance from the edge of the eccentric handle 61 to the pivot 615 along the extending direction of the pull rod 62 will be at its greatest. In other words, along the extending direction of the pull rod 62, the distance between the shim part 342 and the pivot 615 will be at the greatest in the end portion 611 of the eccentric handle 61.

Since the pull rod 62 has a fixed length, the engaging piece 64 will be pulled higher up into the groove 315 of the fixing seat 3 by the pull rod 62 such that an engaging part 64A of the engaging piece 64 can engage with the second positioning part 43 of the turning element 4. In the embodiment of FIG. 12, when viewed from the left side of the folding lock mechanism, the protruding end 4131 of the left downward protruding part 413 will at least be extending down level or past the engaging piece 64 in the groove 315 when the folding lock mechanism is in the unfolded state of FIG. 12 in order to interface with the engaging piece 64. In this manner, the engaging part 64A of the engaging piece 64 will engage with the protruding part 413 (and protruding part 423) and restrict the turning element 4 from being rotated relative to the fixing seat 3. In other different embodiments, the protruding part 413 may not have the protruding end 4131. In this embodiment, the protruding part 413 may be locked or engaged with the top surface of the engaging piece 64 when the folding lock mechanism is in the unfolded state and the eccentric handle 61 is in the upright position.

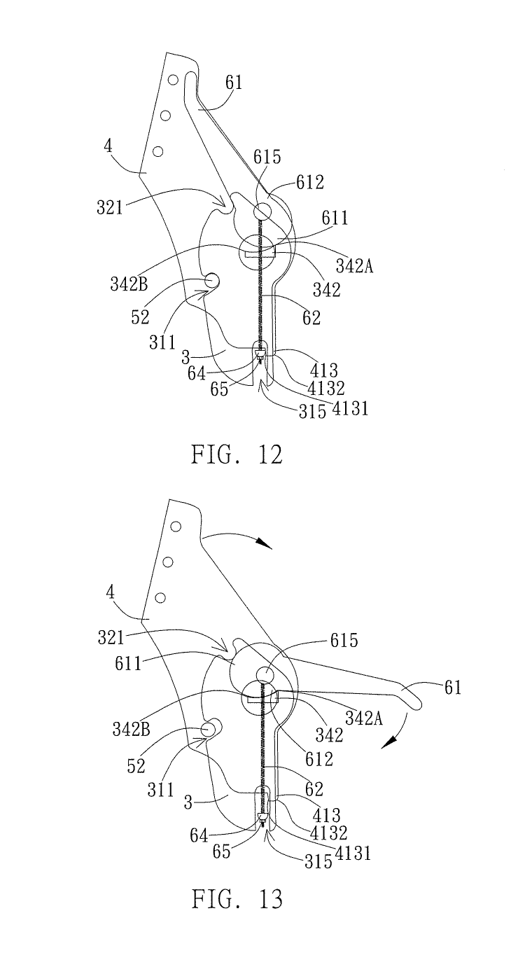

As illustrated in FIG. 13, when the eccentric handle 61 is rotated or pulled down, the eccentric handle 61 will rotate about the pivot 615 along the top surface of the shim part 342. However, since the pivot 615 is off-center from the general circular shape of the end portions 611 and 612 of the eccentric handle 61, as the eccentric handle 61 is pulled down, the distance along the pull rod 62 between the pivot 615 and the shim 342 will decrease until the smallest distance is reached at the end portion 612. In other words, as the eccentric handle 61 is pulled down, the distance between the pivot 615 of the eccentric handle 61 and the shim part 342 will decrease and cause the pull rod 62 to lower downward vertically with respect to the fixing seat 3. As shown in FIG. 13, this will also subsequently lower the engaging piece 64 past the protruding end 4131 of the protruding part 413 such that the engaging piece 64 will no longer be engaged with the turning element 4.

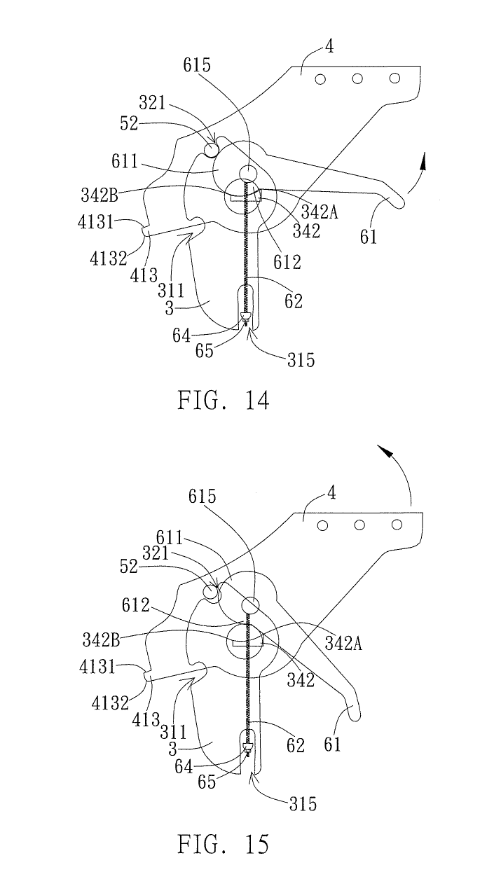

When the positioning rod 52 is disengaged from the fixing seat 3 as illustrated in FIG. 13, since the engaging piece 64 is no longer engaging the protruding part 413 of the turning element 4, the turning element 4 may be rotated towards the direction of the footrest 91 (refer to FIG. 1) as shown in FIG. 14. With the turning element 4 rotated to the position shown in FIG. 14, the positioning rod 52 will then once again engage or lock into the fixing seat 3 at the upper first positioning part 33. The eccentric handle 61 can then be rotated upwards to complete the folded state of the folding lock mechanism. As illustrated in FIGS. 12-14, to ensure that there is smooth operation between the protruding part 413 and the engaging piece 64 when the turning element 4 is rotated into or out of the unfolded state relative to the fixing seat 3, the interfacing surfaces between either the protruding end 4131 and/or the engaging piece 64 can be formed with curved surfaces. In this manner, when the turning element 4 is rotated with respect to the fixing seat 3, the engaging piece 64 and the protruding part 413 can be made to be significantly close to each other without either of them obstructing the motion of the other during the rotating motion.

FIG. 15 illustrates an embodiment of the folding lock mechanism when initially unfolding the folding lock mechanism from the folded state. In the present embodiment, the eccentric handle 61 is pulled downwards such that the entire eccentric handle 61 no longer engages the top surface of the shim part 342 and is instead balanced on the edge between the first side 342A and the top surface of the shim part 342. In other words, since the height of the first side 342A is higher than the second side 342B of the shim part 342, when the eccentric handle 61 is pulled down further and rotated about the pivot 615, the end portions 611 and 612 of the eccentric handle 61 can be lifted up to disengage from the top surface of the shim part 342 and be balanced like a seesaw on the top edge of the front side 342A. When the end portions 611 and 612 are lifted up with respect to the shim part 342 due to the seesaw action, the end portion 611 of the eccentric handle 61 will then engage and drive the positioning rod 52 to disengage from the fixing seat 3. In one embodiment, the end portion 611 of the eccentric handle 61 will engage the positioning rod 52 directly. In other embodiments, the end portion 611 of the eccentric handle 61 will engage the first connection plate 53 or the positioning rod on the other side of the first connection plate 53 from the positioning rod 52 shown in FIG. 11.

With the end portion 611 pushing the positioning rod 52 out of the top positioning part 33 of the fixing seat 3 (as shown in FIG. 15), the turning element 4 may then be rotated away from the footrest 91 towards the unfolded state (as shown in FIG. 16). In other words, by pulling the eccentric handle 61 downwards significantly enough, the positioning rod 52 can be automatically driven to disengage from the fixing seat 3 through the seesaw action of the eccentric handle 61 about the top edge of the front side 342A of the shim part 342. After the turning element 4 is rotated into the unfolded state, the positioning rod 52 can then engage into the bottom first positioning part 33 of the fixing seat 3 to lock the relative positioning between the turning element 4 and the fixing seat 3.

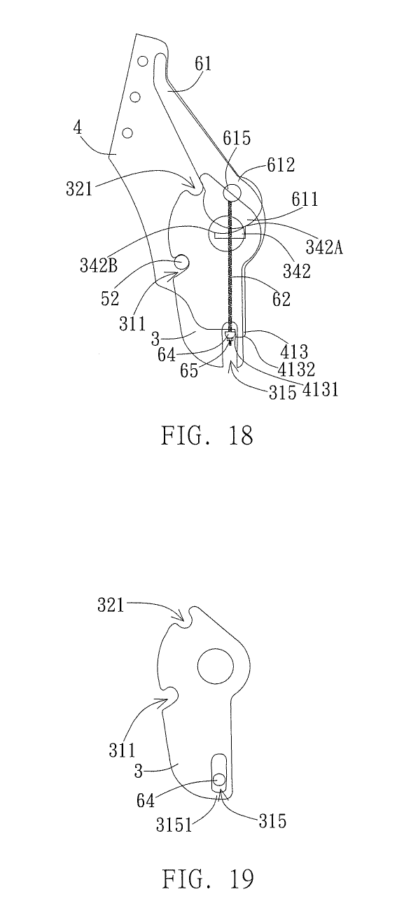

Accordingly, the eccentric handle 61 can then be rotated upwards as shown in FIG. 17 to the position shown in FIG. 18. As illustrated in FIGS. 17 and 18, as the eccentric handle 61 is rotated about the pivot 615, since the pivot is off-center from the circular shape of the end portions 611 and 612, the distance between the pivot 615 and the shim part 342 along the extending direction of the pull rod 62 will increase and cause the pull rod 52 to lift the engaging piece 64 to be pulled up vertically with respect to the fixing seat 3 in the groove 315 to the point where the engaging piece 64 is at least level with the protruding part 413. As mentioned above, when this situation occurs, the engaging piece 64 will then be engaged with the protruding part 413 (and protruding part 423) and restrict the turning element 4 from rotating with respect to the fixing seat 3.

FIG. 19 is another embodiment of the groove 315 of the fixing seat 3. In the present embodiment, in comparison to the open grove 315 of FIGS. 11 to 18, the grove 315 may also be closed by a bridge 3151 to restrict the engaging piece 64 from moving too far downward. The bridge 3151 provides better structural rigidity to the fixing seat 3. Although having the open groove 315 of FIGS. 11 to 18 allows much easier access to the adjustable nut 65 and the engaging piece 64 during maintenance or during replacement of the engaging piece 64, the bridge 3151 however can provide a place to rest the replacement engaging piece 64 while the adjustable nut 65 is prepared to be screwed to the pull rod 62 to fix the engaging piece 64 onto the pull rod 62.

Although the embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A folding lock mechanism for a mobility vehicle, the mobility vehicle has an operation lever and a footrest, the folding lock mechanism comprising:
a fixing seat connected to front end of the footrest and provided with a first positioning part at one end thereof;
a turning element has a second positioning part and a front end, the front end is coupled to the operation lever, and the turning element is pivotally connected with the fixing seat;
a first positioning component connected with the turning element in a way capable of relatively reciprocating rotation, the first positioning component is capable of being engaged with the first positioning part;
a second positioning component connected with the fixing seat in a way capable of relative reciprocating rotation; and
a connection component connected between the first positioning component and the second positioning component;
wherein the second positioning component drives the first positioning component via the connection component to disengage from the first positioning part.

2. The folding lock mechanism of claim 1, wherein the second positioning component further includes an engaging part at one end thereof for being engaged with the second positioning part, and the second positioning component drives the first positioning component via the connection component to disengage from the first positioning part when the second positioning component is turned to disengage the engaging part from the second positioning part.

3. The folding lock mechanism of claim 1, wherein the turning element further includes a left turning plate and right turning plate, and the left turning plate and the right turning plate are respectively and pivotally connected with the fixing seat.

4. The folding lock mechanism of claim 3, wherein the left turning plate and the right turning plate sandwich the first positioning component and the second positioning component.

5. The folding lock mechanism of claim 2, wherein the fixing seat includes a left fixing plate and a right fixing plate, and a rear end of the left fixing plate and a rear end of the right fixing plate are respectively connected to the front end of the footrest.

6. The folding lock mechanism of claim 5, wherein the first positioning part includes a plurality of left recesses formed at a front periphery of the left fixing plate, and a plurality of right recesses formed at a front periphery of the right fixing plate corresponding to the left recesses.

7. The folding lock mechanism of claim 6, wherein the first positioning component further includes a positioning rod; when the folding lock mechanism is in the locked state, the positioning rod is engaged with the first positioning part of the fixing seat and the engaging part of the second positioning component is engaged with the second positioning part of the turning element; when the second positioning part is turned to switch the folding lock mechanism into the unlocked state, the second positioning component disengages the engaging part from the second positioning part while simultaneously driving the first positioning component via the connection component to disengage the positioning rod from the first positioning part.

8. The folding lock mechanism of claim 5, wherein the left fixing plate and the right fixing plate sandwich the first positioning component and the second positioning component.

9. The folding lock mechanism of claim 1, wherein the first positioning component further includes a first connection plate and a second connection plate, one end of the first connection plate is fixed to one end of the second connection plate, and the first connection plate and the second connection plate together form a substantially straight long plate shape.

10. The folding lock mechanism of claim 9, wherein the first connection plate and the second connection plate are uniformly formed.

11. The folding lock mechanism of claim 9, wherein the first positioning component further includes a straight rod and an elastic piece, the straight rod is connected to the end of the first positioning component where the first connection plate connects with the second connection plate, the elastic piece is fitted on the straight rod, and the straight rod is pivotally connected to the turning element.

12. The folding lock mechanism of claim 1, wherein the connection component is formed as a string shape having two washers respectively connected at the ends of the string shape.

13. The folding lock mechanism of claim 12, wherein the second positioning component has a handle and a pull rod, an end of the handle is connected to one end of the pull rod, another end of the pull rod is connected to the engaging piece.

14. The folding lock mechanism of claim 13, wherein the handle has a hole, one of the washer of the connection component is inserted into the hole, and a screw is fitted through the washer from a through-hole in the handle perpendicular to the hole to secure the washer in the hole, and the other washer of the connection component is secured to an end of a second connection plate of the first positioning component.

15. The folding lock mechanism of claim 1, wherein the connection component is formed as a long strip plate shape, wherein the connection component has an elongated hole formed at one end thereon, and the connection component is movably fixed to the first positioning component.

16. The folding lock mechanism of claim 1, wherein the first position component further includes a positioning rod, the positioning rod is inserted into a guiding groove of the turning element, the guiding groove restricts the movement of the positioning rod to limit the range of rotation of the first positioning component.

17. The folding lock mechanism of claim 1, wherein the turning element further includes a left turning plate and right turning plate, the left turning plate and the right turning plate are respectively and pivotally connected with the fixing seat, and the left turning plate and the right turning plate sandwich the fixing seat.

18. The folding lock mechanism of claim 17, wherein the second positioning component further includes a handle, a shim part that is positioned between the handle and the engaging part, and a pull rod where an end of the pull rod is pivotally connected to one end of the handle and another end of the pull rod is connected to the engaging piece.

19. The folding lock mechanism of claim 18, wherein the one end of the handle that is connected to the pull rod has a circular part, and the pull rod is pivotally connected to the handle off-center from the circular part.

20. The folding lock mechanism of claim 19, wherein when the handle is substantially parallel to the pull rod, the pull rod is retracted upward away from the shim part by the circular part such that the engaging piece engages with the second positioning part.

21. The folding lock mechanism of claim 2, wherein the engaging part has at least one flat surface for engaging with the second positioning part.

22. A folding lock mechanism for a mobility vehicle, the mobility vehicle has an operation lever and a footrest, the folding lock mechanism comprising:
a fixing seat connected to front end of the footrest and provided with a first positioning part at one end thereof;
a turning element has a positioning part and a front end, the front end is coupled to the operation lever, and the turning element is pivotally connected with the fixing seat (3);
a first positioning component connected with the turning element in a way capable of relatively reciprocating rotation, the first positioning component is capable of being engaged with the first positioning part;
a second positioning component connected with the fixing seat in a way capable of relative reciprocating rotation;
wherein an end of the second positioning component disengages the first positioning component from the first positioning part.

23. The folding lock mechanism of claim 22, wherein the end of the second positioning component disengages the first positioning component from the first positioning part when the second positioning component is turned to disengage the engaging part from the second positioning part.

24. The folding lock mechanism of claim 23, wherein the second positioning component includes a handle and a rod, and an engaging part at one end of the rod for engaging with the second positioning part, the rod is pivotally connected to the end of the handle, and the pivot between the handle and the rod is off-center at the end of the handle.

25. The folding lock mechanism of claim 24, wherein the rod passes through a shim part, the shim part having a top surface, a first side adjacent to the top surface, and a second side opposite to the first side having height smaller than the first side, the top surface corresponding to the end of the handle.

26. The folding lock mechanism of claim 25, wherein the handle can be balanced on an edge between the top surface and the first side to lift the end of the handle in a seesaw manner off the top surface of the shim part to drive the end to disengage the first positioning component from the first positioning part.

27. The folding lock mechanism of claim 26, wherein the end of the handle has a first end portion and a second end portion, a distance between the pivot and an edge of the first end portion is greater than a distance between the pivot and an edge of the second end portion, and the first end portion extends out from the pivot more parallel to the extending direction of the handle relative to the second end portion extending out from the pivot.

28. The folding lock mechanism of claim 27, wherein along the extending direction of the rod, when the handle is rotated such that the top surface of the shim part goes from engaging the first end portion to engaging the second end portion of the handle, the distance between the pivot and the top surface decreases to drive the rod to force the engaging part connected to one end of the rod to disengage from the second positioning part.

29. The folding lock mechanism of claim 23, the folding lock mechanism further has a folded state and an unfolded state, wherein the second positioning component includes a handle and a rod, the rod is pivotally connected to the end of the handle, and the pivot between the handle and the rod is off-center at the end of the handle.

30. The folding lock mechanism of claim 28, wherein when transitioning from the folded state to the unfolded state:
the handle is rotated downward at a first mode to cause the handle to be balanced as a seesaw and drive the end of the handle to disengage the first positioning component from the first positioning part while lowering the rod to disengage the engaging part from the second positioning part, wherein the turning element is then rotated relative to the fixing seat to the unfolded state;
the handle is rotated upwards at a second mode to lift the rod up to reengage the engaging part with the second positioning part in order to lock the relative rotational position between the turning element and the fixing seat.

31. The folding lock mechanism of claim 28, wherein when transitioning from the unfolded state to the folded state: the handle is rotated downward to lower the rod to disengage the engaging part from the second positioning part, the turning element is rotated relative to the fixing seat to the folded state, and then the handle is rotated upward to lift the rod to drive the engaging part to engage the second positioning part.

32. The folding lock mechanism of claim 23, wherein the fixing seat has at least one groove, the engaging part is restricted in motion by the at least one groove.
